(19) United States
(12) Patent Application Publication
(10) Pub. No.: US 2011/0214788 A1
(43) Pub. Date: Sep. 8, 2011

(54) Tire Crown for an Airplane

(75) Inventors: Francois Chambriard, Beaumont (FR); Sophie Moranne-Beaufils, Gerzat (FR)

(73) Assignees: SOCIETE DE TECHNOLOGIE MICHELIN, Clermont-Ferrand (FR); MICHELIN RECHERCHE et TECHNIQUE S.A., Granges-Paccot (CH)

(21) Appl. No.: 13/002,252

(22) PCT Filed: Jun. 30, 2009
(86) PCT No.: PCT/EP2009/058202

§ 371 Date: May 16, 2011

(30) Foreign Application Priority Data
Jun. 30, 2008 (FR) 0854371

(51) Int. Cl. B60C 11/00; B60C 9/02

(52) U.S. Cl. 152/209.1

(57) ABSTRACT

An airplane tire, whose rated pressure is more than 9 bar and whose deflection under rated load is more than 30%, comprising a tread having a tread surface (41), a crown reinforcement (42) comprising at least one layer of reinforcing elements, and a carcass reinforcement (43) comprising at least one layer of reinforcing elements; said tread surface (41), crown reinforcement (42) and carcass reinforcement (43) being defined geometrically by respective initial meridian profiles. The initial meridian profile of the crown reinforcement (42) is locally concave across a central part whose axial width l₄₂ is at least 0.25 times the axial width L₄₂ of the crown reinforcement.

The present invention relates to airplane tire whose usage is characterized by conditions of high pressure, load and speed and, in particular, whose rated pressure is more than 9 bar and whose deflection under rated load is more than 30%.

By definition, the deflection under rated load of a tire is its radial deformation, or relative variation of radial height, as the latter changes from an unloaded inflated state to a statically loaded inflated state, under the rated conditions of pressure and load defined by the Tire and Rim Association standards. It is defined as the ratio of the variation of the radial height of the tire to half of the difference between the outside diameter of the tire and the maximum diameter of the rim measured on the rim flange. The outside diameter of the tire is measured statically in an inflated unloaded state at the rated pressure.

In this text, the following terms having the meanings indicated:

“Equatorial plane”: the plane perpendicular to the axis of rotation of the tire, passing through the middle of the tire's tread surface.

“Meridian plane”: a plane containing the axis of rotation of the tire.

“Radial direction”: a direction perpendicular to the axis of rotation of the tire.

“Circumferential direction”: a direction perpendicular to a meridian plane.

“Axial direction”: a direction parallel to the axis of rotation of the tire.

“Radial distance”: a distance measured perpendicular to the axis of rotation of the tire, beginning at the axis of rotation of the tire.

“Axial distance”: a distance measured parallel to the axis of rotation of the tire, beginning at the equatorial plane.

“Radially inward of” and “radially outward of”: whose radial distance is less than or greater than, respectively.

“Axially inward of” and “axially outward of”: whose axial distance is less than or greater than, respectively.

Although not limited to this, the invention is more specifically described with reference to an airplane tire whose architecture is presented in document EP 1 381 525, which will be referred to in this text as an ordinary tire.

Such a tire comprises a tread designed to come into contact with the ground, connected by two sidewalls to two beads, each bead connecting the tire to a wheel rim.

The tread, which contains at least one and more often a plurality of circumferential grooves, is designed to come into contact with the ground via a tread surface.

The tire also contains a reinforcement consisting of a crown reinforcement radially inward of the tread, and a radial carcass reinforcement that is radially inward of the crown reinforcement.

The crown reinforcement of an airplane tire usually has at least one layer of mutually parallel reinforcing elements coated in an elastomeric compound. The axial width of the crown reinforcement is the maximum axial width of the crown reinforcement layer.

The radial carcass reinforcement of an airplane tire usually contains at least one layer of mutually parallel reinforcing elements coated in an elastomeric compound and orientated approximately radially—that is, making an angle with the circumferential direction of between 85° and 95°.

The reinforcing elements of the crown reinforcement layers or carcass reinforcement layers, in the case of airplane tires, are usually cables, such as cables made of aliphatic polyamides and/or aromatic polyamides. If the cables are composed of both aliphatic polyamides and aromatic polyamides they are described as hybrid, as indicated in document EP 1 381 525.

Airplane tires in general are commonly observed to exhibit non-uniform wear, known as irregular wear, of the tread, resulting from the stresses in the course of the different life stages of the tire, lift-off, taxiing and landing. A form of wear that has been more particularly observed is a differential wear of the tread between a central part and the two lateral tread parts, axially outward of the central part, the wear in this central part being greater. The differential wear of the central part of the tread results in a limitation on the life of the tire and hence on its use, and results in its premature withdrawal, even though the tread usually only has relatively little wear of the lateral parts of the tread. This is financial disadvantageous.

It is known to those skilled in the art that tire tread wear depends on several factors related to usage and the design of the tire, including, in particular, the geometrical shape of the contact patch of the tire on the ground and the distribution of the mechanical stresses within this contact patch, these two criteria in turn depending on the inflated meridian profile of the tread surface. The inflated meridian profile of the tread surface is the cross section of the tread surface, ignoring any circumferential grooves, in a meridian plane, when the tire is inflated at its rated pressure and not loaded.

To increase the life of the tire, in view of the differential wear of the central part of the tread, the person skilled in the art has sought to optimize the geometrical shape of the inflated meridian profile of the tread surface.

Document EP 1 163 120 discloses a crown reinforcement for an aircraft tire, the object of which is to limit radial deformations during inflation of the tire to its rated pressure, and, consequently, radial deformations of the initial meridian profile of the tread surface. Radial deformations of the crown reinforcement during inflation of the tire to its rated pressure are limited by increasing the circumferential tensile stiffnesses of the crown reinforcement layers, which is done by replacing the reinforcing elements of the crown reinforcement layers—usually aliphatic polyamides—usually made of aliphatic polyamides—with reinforcing elements made of aromatic polyamides. The elastic moduli of the aromatic polyamide reinforcing elements are superior to those of aliphatic polyamide reinforcing elements, so that elongations of the former, under a given tensile stress, are less than those of the latter.

Document EP 1 381 525 mentioned earlier teaches a modification of the geometrical shape of the inflated meridian profile of the tread surface by varying the tensile stiffnesses of the reinforcement layers of the crown and/or of the carcass. The document teaches the use of hybrid reinforcing elements, i.e. elements made of both aliphatic polyamides and aromatic polyamides, in place of the normal aliphatic polyamide reinforcing elements. These hybrid reinforcing elements have higher elastic moduli than aliphatic polyimide reinforcing elements and therefore have less elongation for a given tensile stress. Hybrid reinforcing elements are used in the crown reinforcement layers, to increase circumferential tensile stiffnesses, and/or in the carcass reinforcement layers, to increase tensile stiffnesses in the meridian plane.

Lastly, document EP 1 477 333 teaches another modification of the geometrical shape of the inflated meridian profile of the tread surface by varying axially the overall circumferential tensile stiffness of the crown reinforcement in such a way that the ratio between the overall circumferential tensile stiffnesses of the axially outermost parts of the crown reinforcement and of the central part of the crown reinforcement are within a defined interval. The overall circumferential tensile stiffness of the crown reinforcement is a combination of the circumferential tensile stiffnesses of the crown reinforcement layers. The overall circumferential tensile stiffness of the crown reinforcement varies in the axial direction, depending on the variation of the number of superposed crown reinforcement layers. The proposed solution is based on an axial distribution of the overall circumferential tensile stiffnesses between the central part and the axially outermost parts of the crown reinforcement, with the central part being stiffer than the axially outermost parts of the crown reinforcement. The reinforcing elements used in the crown or carcass reinforcement layers are made of aliphatic polyamides, or aromatic polyamides, or hybrids.

The solutions presented in the prior art described above are still however inadequate to reduce irregular wear of the tread of tires fitted to airliners, where they are exposed to severe stresses, such as, by way of non-restrictive examples, a rated pressure greater than 15 bar, a rated load greater than 20 tons and a top speed of 360 km/h.

The aim of the inventors has been to increase the life over wear of an airplane tire, by limiting the differential wear of the tread between a central part and the lateral parts axially outward of this central part.

This object has been achieved, according to the invention, with an airplane tire, whose rated pressure is more than 9 bar and whose deflection under rated load is more than 30%, this tire comprising a tread having a tread surface, a crown reinforcement comprising at least one layer of reinforcing elements, and a carcass reinforcement comprising at least one layer of reinforcing elements; said tread surface, crown reinforcement and carcass reinforcement being defined geometrically by respective initial meridian profiles; the initial meridian profile of the crown reinforcement being locally concave across a central part whose axial width is at least 0.25 times the axial width of the crown reinforcement.

The initial meridian profile of the tread surface is the meridian curve, obtained by cutting the tread surface on a meridian plane, when a new, i.e. not yet used, tire is in its initial state, i.e. mounted on its rim, inflated to a pressure equal to 10% of its rated pressure, this being the amount of pressure required for correct mounting of the tire on its rim, and not loaded.

The inflated meridian profile of the tread surface is the meridian curve, obtained by cutting the tread surface on a meridian plane, when a new, i.e. not yet used, tire is in its inflated state, i.e. mounted on its rim, inflated to its rated pressure and not loaded. It is the meridian profile of the tread surface resulting from the deformation of the initial meridian profile of the tread surface, when the tire changes from its initial state to its inflated state.

The final meridian profile of the tread surface is the meridian curve, obtained by cutting the tread surface on a meridian plane, when a worn tire, i.e. worn to a level preventing full use on an airplane and necessitating its withdrawal, is in its final state, i.e. mounted on its rim, inflated to its rated pressure and not loaded. It is the meridian profile of the tread surface resulting from the wear of the inflated meridian profile of the tread surface.

Any meridian profile of the tread surface, whether initial, inflated or worn, is continuous and is based on the tread, assumed to be solid, i.e. ignoring the circumferential grooves. Any meridian profile of the initial, inflated or worn tread surface is symmetrical about the equatorial plane and is limited axially by the axially outermost points of the tread surface that contact the ground last of all, when the tire is inflated to its rated pressure and compressed under its rated load.

A meridian profile of the initial inflated or final tread surface is said to be locally concave across a central part of given axial width when, at any point in said continuous central part, which is symmetrical about the equatorial plane, the centre of curvature is positioned radially outward of the meridian profile of the tread surface and when the relative deflection of this central part of the meridian profile of the tread surface is greater than or equal to +0.005.

The relative deflection of the central part of the meridian profile of the tread surface is the ratio of the difference between the radial distance of the end points of the central part of the meridian profile of the tread surface and the radial distance of the central point of the central part of the meridian profile of the tread surface, to the radial distance of the end points of the central part of the meridian profile of the tread surface.

The end points of the central part of the meridian profile of the tread surface are those points of the meridian profile of the tread surface which limit axially the central part, are symmetrical about the equatorial plane and are of the same radial distance.

The central point of the central part of the meridian profile of the tread surface is that point of the meridian profile of the tread surface which is situated in the equatorial plane.

The relative deflection of the central part of the meridian profile of the tread surface which is locally concave in its central part is positive, because the radial distance of the end points of the central part of the meridian profile of the tread surface is greater than the radial distance of the central point of the central part of the meridian profile of the tread surface.

A meridian profile of the initial inflated or final tread surface is said to be locally convex across a central part of given axial width when, at any point in said continuous central part, which is symmetrical about the equatorial plane, the centre of curvature is positioned radially inward of the meridian profile of the tread surface and when the relative deflection of this central part of the meridian profile of the tread surface is less than or equal to −0.005.

The relative deflection of the central part of the meridian profile of the tread surface which is locally convex is negative, because the radial distance of the end points of the central part of the meridian profile of the tread surface is less than the radial distance of the central point of the central part of the meridian profile of the tread surface.

A meridian profile of the initial inflated or final tread surface is said to be locally quasi-cylindrical across a central part of given axial width when, at any point in said continuous central part, which is symmetrical about the equatorial plane, the centre of curvature is positioned either radially inward of or radially outward of the meridian profile of the tread surface and when the relative deflection of this central part of the meridian profile of the tread surface is greater than −0.005 and less than +0.005.

A meridian profile of the crown reinforcement is the meridian curve, obtained by cutting the radially outermost crown reinforcement layer on a meridian plane, in the case of a tire in a given state. It represents the average line of the radially outermost crown reinforcement layer, which is usually symmetrical about the equatorial plane and limited by the end points of said crown reinforcement layer.

In the case of a crown reinforcement comprising a single layer of reinforcing elements, the meridian profile of the crown reinforcement is the meridian profile of the sole crown reinforcement layer.

In the case of a crown reinforcement comprising two or more layers of reinforcing elements, the meridian profile of the crown reinforcement is the meridian profile of the radially outermost crown reinforcement layer, the meridian profiles of all the other crown reinforcement layers radially inward of the preceding layer being parallel to said meridian profile of the radially outermost crown reinforcement layer, across at least a central part.

The notion of parallel curves, for the purposes of the invention, is a generalization of the notion of parallel straight lines: two curves, lying in a meridian plane, are parallel when the difference between the radial distances of two points, each belonging to a respective one of these two curves and situated on the same radial straight line of given axial distance, is constant.

A meridian profile of the carcass reinforcement is the meridian curve, obtained by cutting the radially outermost carcass reinforcement layer on a meridian plane, in the case of a tire in a given state. It represents the average line of the radially outermost carcass reinforcement layer, which is usually symmetrical about the equatorial plane and limited by the end points of said carcass reinforcement layer.

The definition of the meridian profile of the carcass reinforcement, depending on whether it comprises a single layer or two or more layers of reinforcing elements, is similar to that of the meridian profile of the crown reinforcement.

The notions of initial, inflated, final, locally convex, locally concave, and locally quasi-cylindrical meridian profiles across a central part whose given axial width and relative deflection defined for the tread surface, are applicable to the meridian profiles of the crown reinforcement and of the carcass reinforcement.

The inventors have been able to show that the differential wear between the central part and the lateral parts of the tread of an ordinary tire is the result of abrasion of the elastomeric compound of the tread, mostly during landing of the airplane. The reason for this is that, at the moment of landing, the tire makes contact with the ground in the central part of the tread surface, where the generally convex inflated meridian profile has a relative deflection of usually less than −0.03. Before being spun up, the tire slides with friction over the ground, causing the elastomeric material of the tread to be abraded away across the central part of the convex inflated meridian profile of the tread surface in contact with the ground. The result, by the end of the tire's life, is greater wear of the central part of the tread. Also, the depth of abrasion of the elastomeric material of the tread in its central part is greater the greater the absolute value, in the mathematical sense, of the relative deflection of the central part of the convex inflated meridian profile of the tread surface.

In a first embodiment of the invention the inventors add an extra thickness of elastomeric compound, radially outward of the radially outermost crown reinforcement layer, across a central part symmetrical about the equatorial plane, whose axial width is at least 0.25 times the axial width of the crown reinforcement.

For the tire curing stage, the inventors use a curing mould identical to that of the ordinary tire, such that the initial meridian profile of the tread surface of the tire of the invention is identical to that of the ordinary tire, which is generally convex.

This addition of an extra thickness of elastomeric compound across a central part, associated with the use of a curing mould identical to that of the ordinary tire, leads to an initial meridian profile of the crown reinforcement that is locally concave across said central part.

As the tire changes from the initial state to the inflated state, the inflated meridian profile of the crown reinforcement becomes locally quasi-cylindrical across said central part.

Owing to the incompressibility of the elastomeric compound radially outward of the radially outermost crown reinforcement layer, the inflated meridian profile of the tread surface is thus locally convex across said central part and forms a protuberance in the central part.

This convex central part of the tread surface will be worn away first during landings. When this convex central part of the tread surface is worn away, the inflated meridian profile of the tread surface will be locally quasi-cylindrical across said central part and the wear resulting from subsequent landings will be spread evenly across the axial width of the tread surface, resulting in an increase in life over wear, compared with the ordinary tire.

Another advantage of the invention, in this first embodiment, is that it ensures better protection of the crown reinforcement layers, in the event of tread damage, because of the extra thickness of elastomeric compound in the central part.

A supplementary advantage of this first embodiment, related to the use of a curing mould identical to that of the ordinary tire, is that there is no investment in a new curing mould and therefore no extra manufacturing cost.

Lastly, the inventors have also shown that an axial width of the central part of the initial meridian profile of the crown reinforcement, of at least 0.25 times the axial width of the crown reinforcement, is necessary to achieve an advantage in terms of wear.

In a second embodiment of the invention, it is advantageous to have the initial meridian profile of the tread surface locally concave across a central part whose axial width is the same as that across which the initial meridian profile of the crown reinforcement is locally concave, and parallel to the initial meridian profile of the crown reinforcement across this same axial width. The term “parallel” is as defined above.

Owing to the fact that the initial meridian profile of the tread surface and that of the crown reinforcement are parallel across a central part, this embodiment, unlike the first, does not have an extra thickness of elastomeric compound in the central part.

During the change from the initial state to the inflated state, the inflated meridian profile of the tread surface and that of the crown reinforcement become locally quasi-cylindrical across an axial width approximately equal to the axial width of the central part across which the initial meridian profile of the tread surface and that of the crown reinforcement are parallel.

As compared with the ordinary tire, under rated conditions of pressure and load, the axial width of the inflated meridian profile of the tread surface of the tire of the invention increases; therefore the area of abrasion of the elastomeric compound of the tread increases; and the contact pressure applied to the tread surface decreases. The increase in the tread surface and the decrease in the contact pressure contribute to reducing the depth of abrasion of the elastomeric compound of the tread, with each landing. This makes a greater number of landings possible and increases the tire's life.

Also, in this second embodiment, since the initial meridian profile of the tread surface and that of the crown reinforcement are parallel across a central part, with no extra thickness of elastomeric compound, radially outward of the radially outermost crown reinforcement layer, the tire of the invention can be made lighter than the tire of the first embodiment of the invention.

In a third embodiment, it is advantageous to have the initial meridian profile of the carcass reinforcement locally concave across a central part whose axial width is the same as that across which the initial meridian profile of the crown reinforcement is locally concave, and parallel to the initial meridian profile of the crown reinforcement across this same axial.

In a first variant of this third embodiment, the initial meridian profile of the tread surface is convex and identical to that of the ordinary tire. In this configuration the inflated meridian profile of the tread surface is locally convex across the central part, as in the first embodiment, once again giving the advantages in terms of wear and cost of curing mould of the first embodiment.

In a second variant of this third embodiment, the initial meridian profile of the tread surface is locally concave across the central part, across which the initial meridian profile of the crown reinforcement and that of the carcass reinforcement are locally concave, and is parallel to the initial meridian profiles of the crown reinforcement and of the carcass reinforcement. In this configuration the inflated meridian profile of the tread surface is locally quasi-cylindrical, as in the second embodiment, once again giving the advantages in terms of wear and mass as in the second embodiment. Additionally, this configuration makes it possible to minimize the total thickness of the meridian section of the tire, in the end parts of the crown reinforcement, and so reduce the thermal dissipation in this region and increase the endurance of the tire. Besides this, an additional saving in terms of mass of material is obtained because of the fact that the initial meridian profiles of the tread surface, crown reinforcement and carcass reinforcement are parallel across the same central part.

Advantageously also, according to the invention, the axial width of the central part, across which the initial meridian profile of the crown reinforcement is locally concave, is less than or equal to 0.7 times the axial width of the crown reinforcement. This upper limit on the axial width of the central part necessitates initial meridian profiles of the crown reinforcement layers that are locally convex or quasi-cylindrical in the end parts of the crown reinforcement layers. In this configuration the ends of crown reinforcement layers, directed radially towards or parallel to the axis of rotation of the tire are better protected against potential cracks propagating from the tread following damage to said tread.

It is also advantageous for the relative deflection of the central part of the initial meridian profile of the crown reinforcement to be greater than or equal to +0.007. This sort of relative deflection ensures that the geometrical shape of the inflated meridian profile of the tread surface is locally convex or quasi-cylindrical, as intended.

It is also advantageous for the relative deflection of the central part of the initial meridian profile of the crown reinforcement to be less than or equal to +0.03 and preferably less than or equal to +0.025. A relative deflection of this sort avoids causing excessive elongation of the reinforcing elements of the crown and/or carcass reinforcement layers, during the change from the initial state to the inflated state.

In the case of the third embodiment comprising a locally concave initial meridian profile of the carcass reinforcement, it is advantageous to have at least one crown reinforcement layer radially adjacent to a hooping reinforcement, said hooping reinforcement comprising at least one layer of reinforcing elements that is axially symmetrical about the equatorial plane of the tire, and whose axial width is greater than or equal to 0.3 times the axial width across which the initial meridian profile of the carcass reinforcement is locally concave. The hooping reinforcement layers are layers of reinforcing elements separate from those of the crown reinforcement, and therefore do not belong to the crown reinforcement. The transition from the locally concave initial meridian profile of the carcass reinforcement to the inflated meridian profile of the carcass reinforcement generates excess tensile forces in the reinforcing elements of the crown reinforcement layers. The hooping reinforcement limits these excess tensile forces in the reinforcing elements of the crown reinforcement layers, which are greatest in the locally concave central part of the crown reinforcement, by mechanically absorbing some of said forces.

According to the inventors, it is advantageous to have the circumferential tensile stiffness of the hooping reinforcement greater than or equal to 0.2 times the circumferential tensile stiffness of the central part of the crown reinforcement whose axial width is equal to the axial width of the hooping reinforcement. The circumferential tensile stiffness of a reinforcement or part of a reinforcement is the circumferential tensile force to be applied to said reinforcement or part of a reinforcement to obtain a circumferential elongation of said reinforcement or part of a reinforcement of 1 mm. The circumferential tensile stiffness of the hooping reinforcement must be higher the greater the relative deflection of the central part of the initial meridian profile of the crown reinforcement. The overall circumferential tensile stiffness of the crown is the sum of the respective circumferential tensile stiffnesses of the crown reinforcement layers and hooping reinforcement layers.

To obtain the required degree of circumferential tensile stiffness of the hooping reinforcement, it is advantageous for the reinforcing elements of a hooping reinforcement layer to be parallel to each other and inclined, with respect to the circumferential direction, at an angle of between −15° and +15°, and preferably of between −5° and +5.

Advantageously also, the reinforcing elements of the hooping reinforcement layers have an elastic modulus greater than or equal to 0.7 times the elastic modulus of the reinforcing elements of the crown reinforcement layers. Opting for this modulus ensures, according to the inventors, an effective contribution of the reinforcing elements with the hooping reinforcement layers to the mechanical absorption of the excess tensile forces.

It is also advantageous for the reinforcing elements of the hooping reinforcement layers to have an elastic modulus less than or equal to 1.3 times the elastic modulus of the reinforcing elements of the crown reinforcement layers. Beyond this elastic modulus value of the reinforcing elements of the hooping reinforcement layers, the excess tensile forces are mostly absorbed by the reinforcing elements of the hooping reinforcement layers, which results in an unequal contribution to the absorption of the excess tensile forces between the reinforcing elements of the crown reinforcement layers and the reinforcing elements of the hooping reinforcement layers.

An advantageous radial position of the hooping reinforcement is a position radially inward of the radially innermost crown reinforcement layer. Opting for this construction is compatible with a traditional method of building a tire without a hooping reinforcement.

A hooping reinforcement radially outward of the radially outermost crown reinforcement layer is also advantageous, particularly in terms of simplicity of manufacture and hence of financial benefit.

Lastly, a hooping reinforcement positioned radially between two successive crown reinforcement layers is also advantageous in terms of the efficacy of the mechanical absorption of the excess tensile forces.

Advantageously also, the reinforcing elements of the carcass reinforcement layers are parallel to each other and orientated approximately radially: the carcass reinforcement of the tire is said to be radial.

It is also advantageous to have the reinforcing elements of the crown reinforcement layers parallel to each other and inclined, with respect to the circumferential direction, at an angle of between −20° and +20°, and preferably of between −10° and +10°. When the angle of inclination of the reinforcing elements of the crown reinforcement layers is between −10° and +10°, these reinforcing elements are said to be orientated approximately circumferentially. In the case of a crown reinforcement containing several layers of reinforcing elements, angles with an absolute value of greater than 20° are conceivable.

Advantageously also, the reinforcing elements of the carcass reinforcement layers are made of textile materials, preferably aliphatic polyamides and/or aromatic polyamides. Aliphatic or aromatic polyamides are the materials normally used in the technical field of airplane tires, principally because of their low densities and mechanical properties.

Lastly, it is advantageous for the reinforcing elements of the crown reinforcement layers to be made of textile materials, preferably aliphatic polyamides and/or aromatic polyamides, for their low densities and mechanical properties.

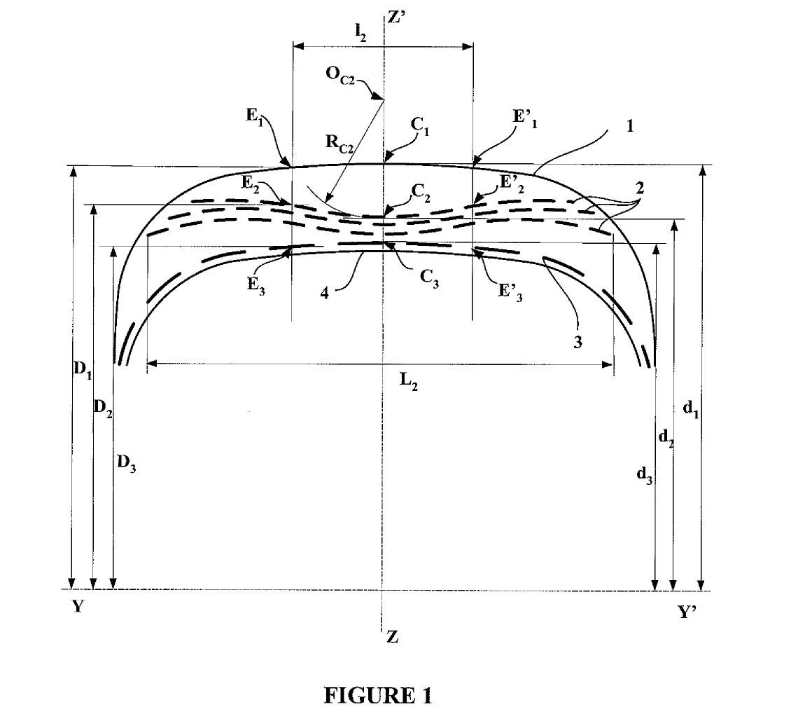

The features of the invention will be understood more clearly in the light of the description of the attached FIGS. 1 to 6:

FIG. 1 is a cross section in a meridian plane through the crown of an airplane tire, in its initial state, in a first embodiment of the invention.

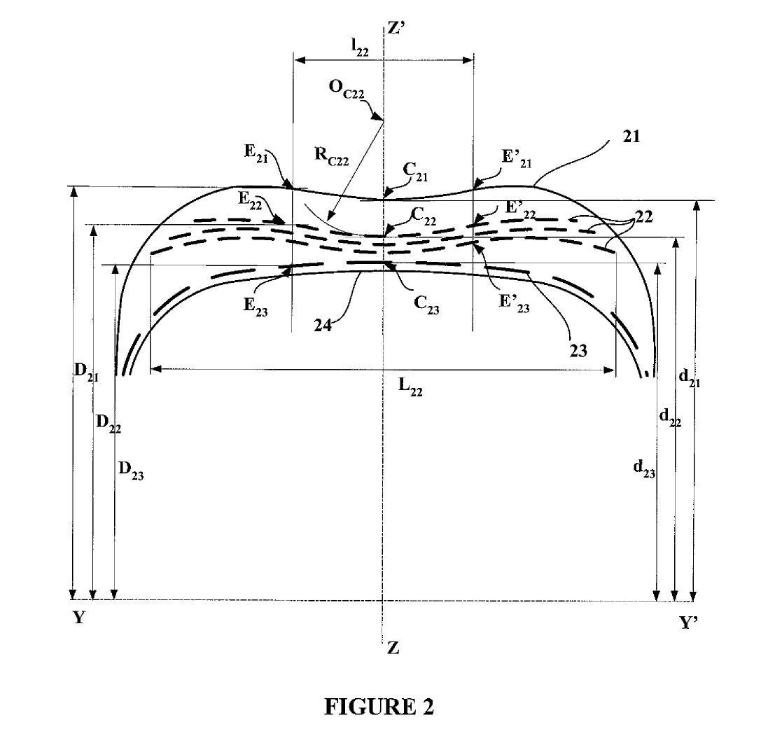

FIG. 2 is a cross section in a meridian plane through the crown of an airplane tire, in its initial state, in a second embodiment of the invention.

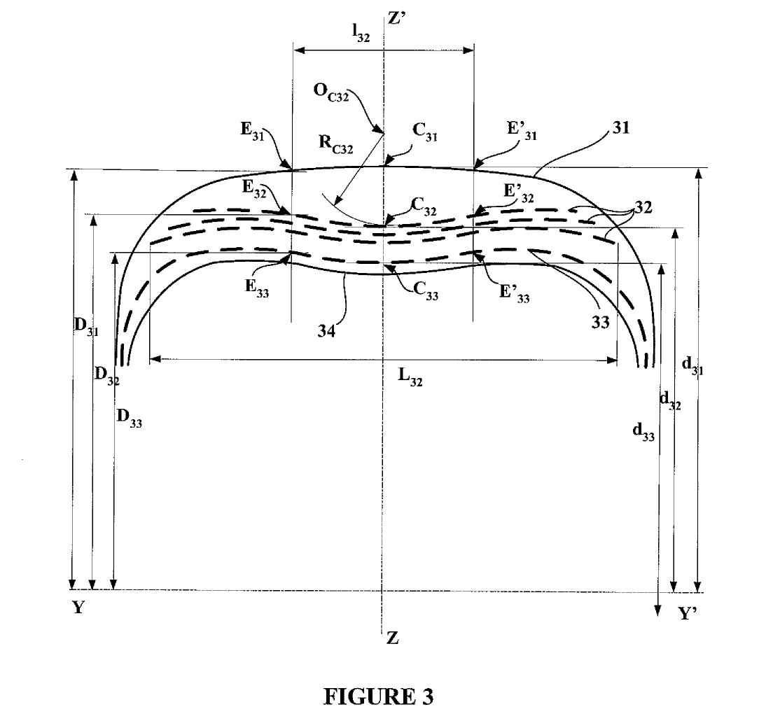

FIG. 3 is a cross section in a meridian plane through the crown of an airplane tire, in its initial state, in a third embodiment of the invention.

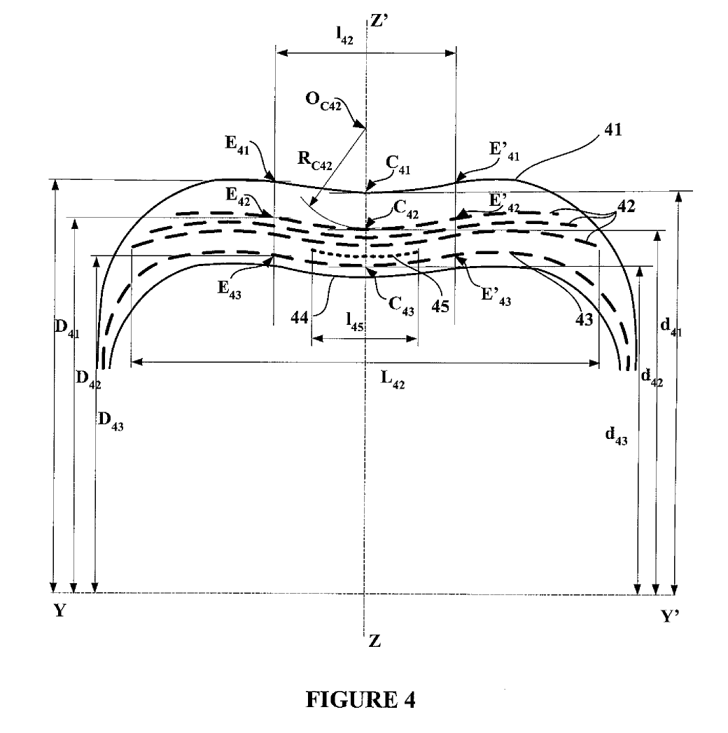

FIG. 4 is a cross section in a meridian plane through the crown of an airplane tire, in its initial state, in a fourth embodiment of the invention.

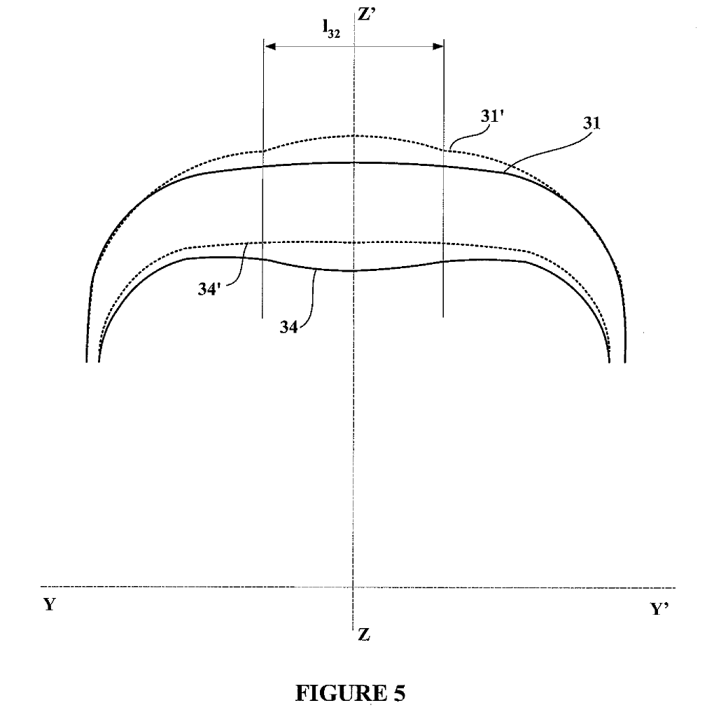

FIG. 5 is a cross section in a meridian plane through the crown of an airplane tire, comparing the initial state to the inflated state, in the embodiment illustrated in FIG. 3.

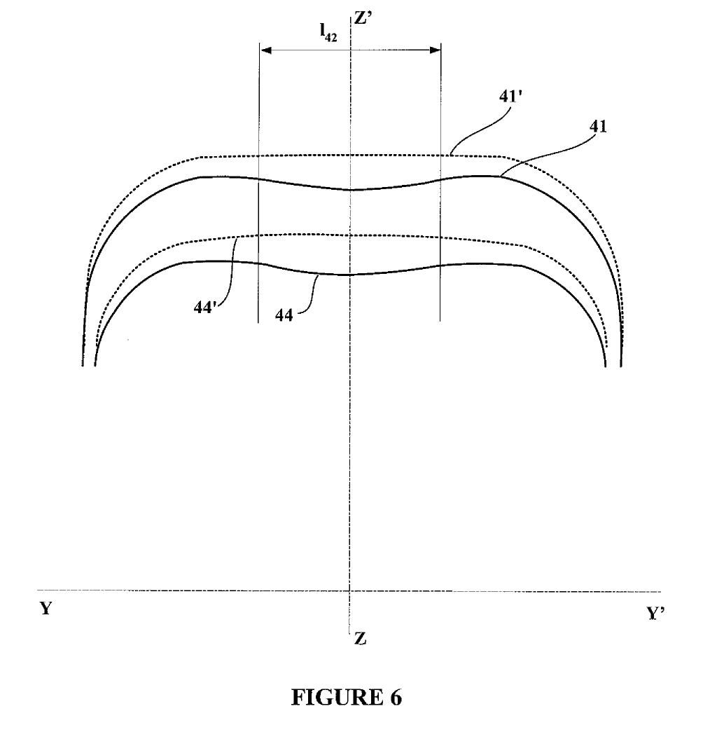

FIG. 6 is a cross section in a meridian plane through the crown of an airplane tire, comparing the initial state to the inflated state, in the embodiment illustrated in FIG. 4.

For ease of understanding, FIGS. 1 to 6 are not shown to scale.

FIG. 1 shows, the radially outermost, the initial meridian profile of the tread surface 1. The central point C₁ (situated in the equatorial plane represented in the meridian plane by the axis ZZ′) of the central part of the initial meridian profile of the tread surface 1 is positioned at the radial distance d₁, measured from the axis of rotation YY′ of the tire. The points E₁ and E′₁ of the initial meridian profile of the tread surface 1, which are symmetrical about the equatorial plane and of radial distance D₁, are the end points of the central part of the initial meridian profile of the tread surface 1 and are axially separated by the axial width l₂, across which the initial meridian profile of the crown reinforcement 2 is locally concave. In FIG. 1, the initial meridian profile of the tread surface 1 is convex.

Radially inward of the initial meridian profile of the tread surface 1 is the initial meridian profile of the crown reinforcement 2—that is, the initial meridian profile of the radially outermost crown reinforcement layer 2, since the crown reinforcement consists, in the example shown in FIG. 1, of three superposed crown reinforcement layers 2. The axial width of the crown reinforcement, which corresponds to the maximum axial width of the crown reinforcement layer, is L₂. The initial meridian profile of the crown reinforcement 2 is locally concave across the central part whose axial width is l₂, across which all the crown reinforcement layers 2 are parallel. The central point C₂ (situated in the equatorial plane) of the central part of the initial meridian profile of the crown reinforcement 2 is positioned at the radial distance d_{z}. The concavity of the initial meridian profile of the crown reinforcement 2 in C₂ is defined by the centre of curvature O_{C2} and the radius of curvature R_{C2}. The points E₂ and E′₂ of the initial meridian profile of the crown reinforcement 2, which are symmetrical about the equatorial plane and of radial distance D₂, are the end points of the central part of the initial meridian profile of the crown reinforcement 2, which are axially separated by the axial width l₂ across which the initial meridian profile of the crown reinforcement 2 is locally concave.

Radially inward of the initial meridian profile of the radially innermost crown reinforcement layer is the initial meridian profile of the carcass reinforcement 3. In FIG. 1 the carcass reinforcement 3 consists of a single carcass reinforcement layer, and so the initial meridian profile of the carcass reinforcement 3 is the initial meridian profile of the only carcass layer. The central point C₃ (situated in the equatorial plane) of the central part of the initial meridian profile of the carcass reinforcement 3 is positioned at the radial distance d₃. The points E₃ and E′₃ of the initial meridian profile of the carcass reinforcement 3, which are symmetrical about the equatorial plane and of radial distance D₃, are the end points of the central part of the initial meridian profile of the carcass reinforcement 3, which are axially separated by the axial width l₂ across which the initial meridian profile of the crown reinforcement 2 is locally concave. In FIG. 1, the initial meridian profile of the carcass reinforcement 3 is convex.

Radially inward of the initial meridian profile of the radially innermost carcass reinforcement layer 3 is the initial meridian profile of the inner surface 4 of the tire, on which the inflation pressure acts, and which adopts the shape of the initial meridian profile of the carcass reinforcement 3.

FIG. 2 differs from FIG. 1 in that the initial meridian profile of the tread surface 21 is locally concave across the central part of axial width l₂₂.

FIG. 3 differs from FIG. 1 in that the initial meridian profile of the carcass reinforcement 33 is locally concave across the central part of axial width l₃₂. The initial meridian profile of the inner surface 34 of the tire, which adopts the shape of the carcass reinforcement 33, is also locally concave across the central part of axial width l₃₂.

FIG. 4 differs from FIG. 3 in that the initial meridian profile of the tread surface 41 is locally concave across the central part of axial width l₄₂. Furthermore, a hooping reinforcement 45, consisting of a layer of reinforcing elements, whose initial meridian profile has an axial width l₄₅, is positioned radially inward of the radially innermost crown reinforcement layer 42.

FIG. 5 shows how the respective initial meridian profiles of the tread surface 31 and inner surface 34 of the tire (illustrated in FIG. 3) arrive at the respective inflated meridian profiles of the tread surface 31′ and inner surface 34′ of the tire. The initial meridian profile of the convex tread surface 31 arrives at the inflated meridian profile of the tread surface 31′, which is locally convex across the central part of axial width l₃₂. The initial meridian profile of the inner surface 34 of the tire, which is locally concave across the central part of axial width l₃₂, arrives at the inflated meridian profile of the inner surface 34′ of the tire, which is locally quasi-cylindrical across the central part of axial width l₃₂. For clarity of the drawing, the initial meridian profiles and inflated meridian profiles of the crown reinforcement and carcass reinforcement are not shown.

FIG. 6 shows how the respective initial meridian profiles of the tread surface 41 and inner surface 44 of the tire, illustrated in FIG. 4, arrive at the respective inflated meridian profiles of the tread surface 41′ and inner surface 44′ of the tire. The initial meridian profile of the tread surface 41, which is locally concave across the central part of axial width l₄₂, arrives at the inflated meridian profile of the tread surface 41′, which is locally quasi-cylindrical across the central part of axial width l₄₂. The initial meridian profile of the inner surface 44 of the tire, which is locally concave across the central part of axial width l₄₂ arrives at the inflated meridian profile of the inner surface 44′ of the tire, which is locally quasi-cylindrical across the central part of axial width l₄₂. For the sake of clarity of the drawing, the initial and inflated meridian profiles of the crown reinforcement and carcass reinforcement are not shown.

The invention has been designed more specifically for an airplane tire of size 46×17.0R20, intended for mounting on the main landing gear of an airliner. For such a tire the rated inflation pressure is 15.3 bar, the rated static load 21 tons and the maximum speed 360 km/h.

The 46×17.0R20 tire has been designed according to the invention, in the embodiment shown schematically in FIG. 4, with initial meridian profiles for the tread surface, for the crown reinforcement and for the carcass reinforcement that are parallel to each other and locally concave across a central part of axial width l₄₂. This tire also includes a hooping reinforcement of axial width l₄₅ that is radially inward of the radially innermost crown reinforcement layer.

The axial width l₄₂ of the locally concave central part of the initial meridian profile of the crown reinforcement, and the axial width L₄₂ of the initial meridian profile of the crown reinforcement are 160 mm and 300 mm, respectively, so the axial width l₄₂ is 0.53 times the axial width L₄₂, and therefore is at least 0.25 times the axial width L₄₂.

In the initial state illustrated in FIG. 4, the radial distances of the central point d₄₂ and of the end points of the central part of the initial meridian profile of the crown reinforcement D₄₂ are 544 mm and 548 mm, respectively. Accordingly the relative deflection of the central part of the initial meridian profile of the locally concave crown reinforcement is +0.0073.

In the inflated state, the radial distances of the central point and of the end points at the central part of the inflated meridian profile of the crown reinforcement are 564 mm and 565 mm, respectively. Accordingly the relative deflection of the central part of the inflated meridian profile of the crown reinforcement is +0.0018. This value confirms that the inflated meridian profile of the crown reinforcement, and hence the respective inflated meridian profiles of the tread surface and of the carcass reinforcement which are parallel to it across the central part of axial width l₄₂, are locally quasi-cylindrical across this central part.

The axial width l₄₅ of the initial meridian profile of the hooping reinforcement and the axial width l₄₂ of the locally concave central part of the initial meridian profile of the carcass reinforcement are 55 mm and 160 mm, respectively, so the axial width l₄₅ is 0.35 times the axial width l₄₂, and therefore at least 0.3 times the axial width l₄₂.

The 46×17.0R20 tire built according to the invention comprises reinforcing elements for the crown reinforcement and hooping reinforcement layers that are made of hybrid materials, and also comprises reinforcing elements for the carcass reinforcement layers that are made of aliphatic polyamide type materials.

The inventors have performed comparative wear tests to compare the tire according to the invention, described above, and the ordinary tire as described in document EP 1 381 525—that is, with initial meridian profiles of the tread surface, crown reinforcement and carcass reinforcement that are not locally concave.

On the basis of the results of these comparative wear tests, the inventors estimate that the tire according to the invention, compared with the ordinary tire, doubles the theoretical number of landings and gives an overall increase of 30% in terms of life over wear on the whole of the use cycle, including landing, taxiing and braking phases.

This increase in life over wear of the tire according to the invention, obtained by virtue of a more even wear of the tread, is also advantageous when it comes to retreading the tire, i.e. replacing the worn tread of the tire at the end of its life.

For an ordinary tire at the end of its life, the tread of which has differential wear between the central part and the lateral parts, the retreading operation usually requires not only removing the worn tread but also removing a layer of usually metallic reinforcing elements, known as the crown reinforcement protection layer, which is radially inward of and adjacent to the elastomeric compound of the tread, since this crown reinforcement protection layer is usually damaged.

For a tire according to the invention, a more even wear across the axial width of the tread means that it is no longer necessary to remove the crown reinforcement protection layer, since this is undamaged at the end of the life of the tire. This reduces the cost of the retreading operation.

To ensure the integrity of the crown reinforcement protection layer, it may be advantageous to lay, radially outward of said protection layer, a layer of coloured elastomeric compound, which will gradually become visible as the tread wears down, to indicate the proximity of the crown reinforcement protection layer and indicate the need to withdraw the tire, optionally for retreading.

The invention should not be interpreted as being limited to the examples illustrated in the figures but rather can be extended to other variants, relating for example to the component materials of the reinforcing elements of the crown and/or carcass reinforcement layers: without implying any restriction, carbon, glass etc.

1. An airplane tire, whose rated pressure is more than 9 bar and whose deflection under rated load is more than 30%, comprising:
a tread having a tread surface;
a crown reinforcement comprising at least one layer of reinforcing elements; and
a carcass reinforcement comprising at least one layer of reinforcing elements; wherein said tread surface, crown reinforcement and carcass reinforcement are defined geometrically by respective initial meridian profiles; said
wherein the initial meridian profile of the crown reinforcement is locally concave across a central part whose axial width is at least 0.25 times the axial width of the crown reinforcement.

2. The tire according to claim 1, wherein the initial meridian profile of the tread surface is locally concave across a central part whose axial width is the same as that across which the initial meridian profile of the crown reinforcement is locally concave, and wherein the initial meridian profile of the tread surface is parallel to the initial meridian profile of the crown reinforcement across this same axial width.

3. The tire according to claim 1, wherein the initial meridian profile of the carcass reinforcement is locally concave across a central part whose axial width is the same as that across which the initial meridian profile of the crown reinforcement is locally concave, and wherein the initial meridian profile of the carcass reinforcement is parallel to the initial meridian profile of the crown reinforcement across this same axial width.

4. The tire according to claim 1, wherein the axial width of the central part, across which the initial meridian profile of the crown reinforcement is locally concave, is less than or equal to 0.7 times the axial width of the crown reinforcement.

5. The tire according to claim 1, wherein the relative deflection of the central part of the initial meridian profile of the crown reinforcement is greater than or equal to +0.007.

6. The tire according to claim 1, wherein the relative deflection of the central part of the initial meridian profile of the crown reinforcement is less than or equal to +0.03 and preferably less than or equal to +0.025.

7. The tire according to claim 3, wherein at least one crown reinforcement layer is radially adjacent to a hooping reinforcement, said hooping reinforcement comprising at least one layer of reinforcing elements that is axially symmetrical about the equatorial plane of the tire, and whose axial width l₄₅ is greater than or equal to 0.3 times the axial width l₄₂ across which the initial meridian profile of the carcass reinforcement is locally concave.

8. The tire according to claim 7, wherein the circumferential tensile stiffness of the hooping reinforcement is greater than or equal to 0.2 times the circumferential tensile stiffness of the central part of the crown reinforcement whose axial width is equal to the axial width l₄₅ of the hooping reinforcement.

9. The tire according to claim 8, wherein the reinforcing elements of a hooping reinforcement layer are parallel to each other and inclined, with respect to the circumferential direction, at an angle of between −15° and +15°.

10. The tire according to claim 9, wherein the reinforcing elements of the hooping reinforcement layers have an elastic modulus greater than or equal to 0.7 times the elastic modulus of the reinforcing elements of the crown reinforcement layers.

11. The tire according to claim 10, wherein the reinforcing elements of the hooping reinforcement layers have an elastic modulus less than or equal to 1.3 times the elastic modulus of the reinforcing elements of the crown reinforcement layers.

12. The tire according to claim 11, wherein the hooping reinforcement is radially inward of the radially innermost crown reinforcement layer.

13. The tire according to claim 11, wherein the hooping reinforcement is radially outward of the radially outermost crown reinforcement layer.

14. The tire according to claim 11, wherein the hooping reinforcement is positioned radially between two successive crown reinforcement layers.

15. The tire according to claim 1, wherein the reinforcing elements of the carcass reinforcement layers are parallel to each other and orientated approximately radially.

16. The tire according to claim 1, wherein the reinforcing elements of the crown reinforcement layers are parallel to each other and inclined, with respect to the circumferential direction, at an angle of between −20° and +20°.

17. The tire according to claim 1, wherein the reinforcing elements of the carcass reinforcement layers are made of textile materials, preferably aliphatic polyamides and/or aromatic polyamides.

18. The tire according to claim 1, wherein the reinforcing elements of the crown reinforcement layers are made of textile materials.

19. The tire according to claim 7, wherein the reinforcing elements of the hooping reinforcement layers are made of textile materials.

20. The tire according to claim 8, wherein the reinforcing elements of a hooping reinforcement layer are parallel to each other and inclined, with respect to the circumferential direction, at an angle of between −5° and +5°

21. The tire according to claim 1, wherein the reinforcing elements of the crown reinforcement layers are parallel to each other and inclined, with respect to the circumferential direction, at an angle of between −10° and +10°.

22. The tire according to claim 1, wherein the reinforcing elements of the crown reinforcement layers are made of aliphatic polyamides and/or aromatic polyamides.

23. The tire according to claim 7, wherein the reinforcing elements of the hooping reinforcement layers are made of aliphatic polyamides and/or aromatic polyamides.
